(19) United States
(12) Patent Application Publication
(10) Pub. No.: US 2003/0037131 A1
(43) Pub. Date: Feb. 20, 2003

(54) User information coordination across multiple domains

(75) Inventor: Dinesh C. Verma, Mt. Kisco, NY (US)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY

(21) Appl. No.: 09/932,735

(22) Filed: Aug. 17, 2001

(51) Int. Cl. G06F 15/173

(52) U.S. Cl. 709/223

(57) ABSTRACT

Methods and apparatus for sharing user information across the Internet, trackers and servers, in multiple domains. User-tracking mechanism deploy cookies placed in web-browser to track an user preference, or use URL rewriting techniques. In an embodiment, a first web site desiring to coordinate cookie information with a second web site creates a cookie in the browser, and stores information related to the information in the cookie in a cookie coordinator database. It directs the client to access a resource at the second web site. The URL of the resource on the second web site encapsulates the information about the location of the client record in a cookie coordinator database. The second web site places its own cookie on the client browser, and coordinates its information with the information in the cookie of the first web-browser by accessing the client record in the cookie coordinator database.

### FIELD OF THE INVENTION

This invention is directed to the field of computer networks. It is more particularly directed to the Internet, trackers and servers that use cookies.

### BACKGROUND OF THE INVENTION

The Internet Protocol (usually referred to as IP) provides network connectivity to users across the world. The most common application in networks running this protocol is the HTTP protocol, which allows a web-browser to access a web-server over the Internet. HTTP is a request-response protocol, and is designed to be stateless. A stateless protocol is one that does not require either the client or server to remember any information from prior interactions.

For many types of web-based exchanges over the Internet, it is desirable to maintain some state across the different requests of the HTTP protocol. We refer to a scheme that can identify an user across multiple HTTP sessions as an user tracking mechanism. The most common user tracking mechanisms is for the web-server to store a cookie at the web-browser. A cookie is data that is placed within the web-browser by a client. This data is sent to the server by the browser whenever it makes a new request to the browser. Typically cookies are used to store the identity of an user so that multiple visits can be correlated. They can also store the profile or preferences of an user, or security credentials which allow an user to access specific content at a web-server.

When a server places a cookie on the browser, it can specify that the cookie be sent to servers other than itself. Adding other sites to the site to which the cookies can be sent allows cookie information to be shared with other servers. Restricting the sites that a cookie gets delivered helps in maintaining the security and privacy of data placed in the cookies. However, the current implementation of cookies in web browsers restricts the set of servers that can be specified to receive the cookie set in this manner. If a server sets a cookie, it can also request that the cookie be sent to other servers which share a domain name suffix with it. Thus, a server with domain name,

www.watson.ibm.com

can set a cookie to be set in the browser so that the cookie is sent only to

www.watson.ibm.com,

or to any machine with the name ending in

watson.ibm.com,

or to any machine with the name ending in

ibm.com,

or to any machine with the name ending in ‘.com’. The last choice in the list will send the cookie to all the machines in the ‘.com’ domain. If a cookie contains information that is sensitive, e.g. the security credentials of the users, it is highly undesirable that the information be sent to many machines.

In many situations, it is desirable that the cookie information be shared with members of another domain As an example, a server

www.watson.ibm.com

may want to share its cookie information with the server,

www.berkeley.edu.

However, with the current way cookies are supported does not make it possible to set a cookie which will only be shared between these two servers. The only option would be to have a cookie that is sent to all the servers within the Internet, which is highly undesirable.

The same problem is experienced by other user tracking mechanisms. As an example, one common user tracking mechanism uses URL rewriting. In this mechanism, the content presented to an user is rewritten so that an unique tag is present in all links that the user may access. As the user clicks on the appropriate link, the tag is carried on to the site, and identifies the user across the sessions. When two sites use independent tags to track users, they are unable to correlate the user at one site with the user on the other site.

For purposes of this invention, we use the term user tracking mechanisms to refer to cookies; URL rewriting or other techniques that are used to identify users accessing a web-site; a domain to refer to a set of servers with whom the normal operation of the user-tracking mechanism can be used to share operations; and an user tracker as a server which employs an user tracking mechanism. It would be advantageous to be able to use the same user tracking mechanism across more than one domain, in which heretofore normal operation of the user tracking mechanism can not be used.

### SUMMARY OF THE INVENTION

It is therefore an aspect of the present invention to provide a method by which two web servers and/or user trackers operating in two different domains can correlate user tracking information.

It is a further aspect of the invention to provide an apparatus by which two servers and/or user trackers operating in two different domains can correlate user tracking information.

It is a further aspect of the invention to enable a same user tracking mechanism to be used across more than one domain, where normal operation of the user tracking mechanism can not be used.

It is a further aspect of the present invention to provide a method and apparatus by which two web-servers and/or user trackers operating in two different domains can correlate cookies placed into a browser independently by them. It is a further aspect of the present invention to provide a method and apparatus by which two web-servers and/or user trackers can correlate user tracking information created as a result of URL rewriting mechanisms.

In an example embodiment of the invention, a web server and/or user trackers in one DNS domain establishes a cookie containing an identity field at a client's browser, redirects the client to a second web-browser with an uRL containing the identity field created in the cookie. The second web-browser creates a cookie with a second identity field, and stores the first identity field and the second identity fields in a global database. The database information is retrieved by the two web-servers to correlate the cookie information.

In an alternative embodiment, a global database need not be maintained, but rather each web-server maintains its own local database containing the identity of the different users. Each of the servers creates an unique identity for the client browser, and redirects the client to access an uRL at the other server which is used to create a local database correlating the two identities. Links from one server's pages to another are rewritten to carry the unique identities in the two sites. Applications of this invention include, but are not limited to: systems that correlate user identities across multiple domains, systems that provide single sign on support across multiple domains, systems that store user preferences based on client identity, etc.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 shows an example of an environment having multiple Internet domains and the problems associated with using cookies established in one domain with those of other domains;

FIG. 2 shows an example of a system that would allow a sharing of user information across two or more DNS domains by a web-server;

FIG. 3 shows a flowchart that illustrates an example of a method used for sharing user information across two domains by one of the web-servers among a pair of web-servers that wishes to share its user information;

FIG. 4 shows a flowchart that illustrates an example of a method used for sharing user information across two domains by the second web-server among the pair that wishes to share their user information; and

FIG. 5 shows an example of an apparatus that can be used for sharing user information across web servers that are located in two different domains.

Other objectives and a better understanding of the invention may be realized by referring to the detailed description.

### DESCRIPTION OF THE INVENTION

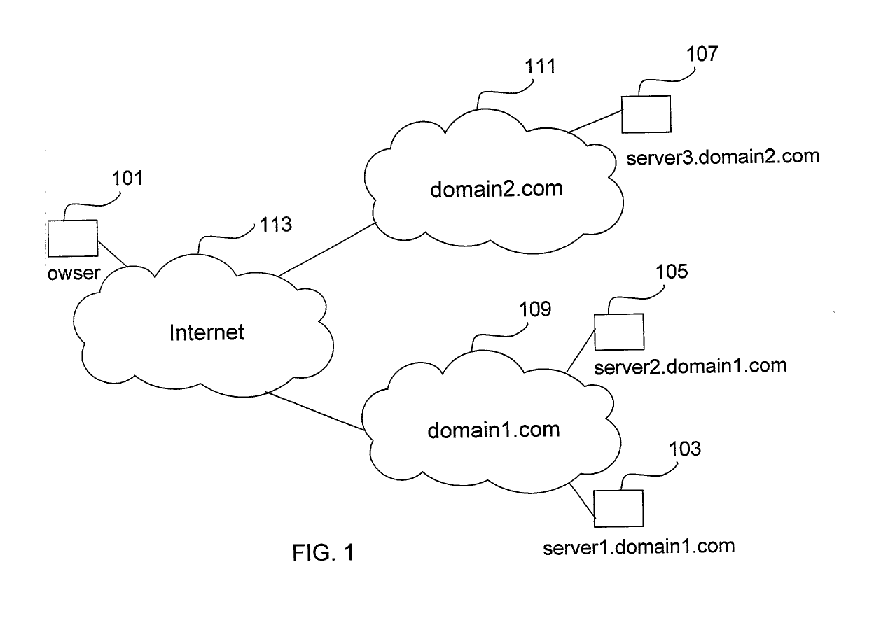

The present invention provides methods and apparatus for sharing cookies and/or cookie-like objects within the Internet, trackers and/or servers. A typical environment in which user information is tracked within an IP network in shown in FIG. 1. It shows a browser 101 and three servers 103 105 107. The browsers and the servers are connected over an IP network 113. An example of the IP network 109 would be the public Internet. The IP network consists of several domains, two of which are shown in the figure. The domain 109 consists of all servers with the name,

domain1.com

and it contains two of the servers shown, namely the server,

server1.domain1.com

103 and,

server2.domain1.com

105. The domain 111 consists of all servers with the name,

domain2.com

and it contains the server,

server3.domain2.com

107. The server and domain names used in the figure are for illustrative purposes only.

Within the environment shown in FIG. 1, the servers may use a cookie mechanism to track user information. When,

server1.domain1.com

103 places a cookie on the browser 101, it can instruct that the cookie be shared with the other servers in the domain,

domain1.com

109. Thus, the two servers 103 and 105 can access the cookies placed into the browser by each other and can track user information by using a shared format for cookie data. However,

server1.domain1.com

103 can not request that the browser send the same cookie to a server in the other domain

domain2.com

111. Thus, the cookie information placed on the browser by,

server1.domain1.com

103 can not be shared by,

server3.domain2.com

107 since it is in another domain 111. Under the well-known rules of cookie sharing, the only way such sharing can be obtained is by defining a cookie to go to all machines with a name suffix of ‘.com’. Clearly, this would be highly undesirable.

Instead of cookies, an alternative way to share user identity is to use the technique of URL rewriting in accordance with the present invention. In the context of URL rewriting, an unique identity is assigned to an user when the user first contacts a server. This identity is embedded in the URL which is passed to the user, and all links provided to the user are included in a similar fashion. The identity being used for an user is local to a server. In general, two servers can not share the information about a rewritten URL without explicit prior agreement. As opposed to cookies, the identity association of the user is not stored by the browser, and each identity association is specific to a particular session.

As an example of URL rewriting, consider a company which is accessed through its portal

http://www.company.com

The technique of user tracking using URL rewriting would have the web-server for the site redirecting users accessing the site

http://www.company.com

to another URL

http://www.company.com/<identity>/index.html.

The <identity> field is generated as an unique identifier for the specific session. If the links embedded in the page index.html (and other pages) are all relative, or if the server modifies the contents of a page to include the <identity> tag in all referenced links; the <identity> field would be part of the URL whenever the user clicks on any embedded links within the page under the normal conventions of HTTP protocol.

By looking at the <identity> field, the web site can determine who the user accessing a page is. However, if the user accesses the page,

http://www.company.com

again by explicitly typing the URL in a browser window (instead of following a link), he will get a new value for the <identity> field.

In many cases, it is highly desirable to know about the identity of the user when he goes from one site in a domain to a second site in another domain. This may be desirable so that a consistent set of information be displayed to the user across the domains, so that a single-sign on scheme be implemented, or simply for the purpose of identifying the common set of users in the two domains.

In an embodiment in accordance with the present invention, basic operation of the system follows a scheme in which each of the different domains uses their own user-tracking mechanism. When using cookies, they each set their own independent cookies at the browser. However, they also follow an additional step of coordinating the identity information contained in the cookie with each-other. This coordination allows the user to be tracked across multiple domains.

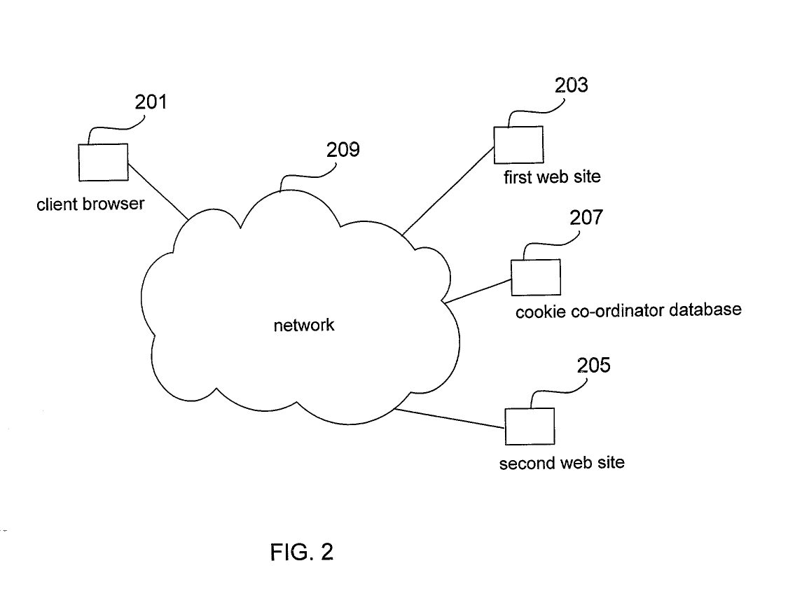

An example embodiment of a system which can be used to implement the cookie sharing mechanism is shown in FIG. 2. The user 201 accesses two sites, first site 203 and second site 205. The user 201, the first site 203, the second site 205 and a cookie coordination database 207 are connected together by the network 209. When the user accesses site 1 203, the site assigns its own identity to the user. When the user accesses the first site 203, the site 203 uses its user tracking mechanism to assign an identity to the user, and stores information about the user at the cookie coordination database 207. The first site 203 also directs the client to access a resource at the second site 205. This can be done by means of a HTTP redirection, or by means of placing a link to the second site 205 in the page being sent to the client by the first site 203. The link or redirection encapsulates information about the location of the record in the cookie coordination database 207 identifying the client information. When the second site 205 is accessed by the client, the site decapsulates the location of the client in the cookie coordination database 207, and creates its own user tracking mechanism to identify the client. The second site 105 can also store information about its user tracking mechanism in the cookie coordination database 207 enabling the first site to 203 access the identity of the user at the second site 205.

As an example, consider the case where the user tracking mechanism used by the two sites is a cookie. The first site 203 will place a cookie cookie-one in the user's browser. Let us assume that the cookie has an identity field which is selected to have the value of id-one by the first site. The first site 203 stores this information as the k-th record in the database 207. It includes a link to an image in the page being sent to the client which asks the client to load an image located at the relative URL/location=k/image.gif at the second site. Since the link directs the client to load an image from the second site, the second site will also place its own independent cookie at the user's browser. Let us say that the cookie contains an identity id-two for the second site 205. The second site 205 can now update the k-th record at the database 207 to store the value of id-two. It can also look up the fact that this is the same client as the one identified by id-one at the first site 203.

Those skilled in the art will realize that there are other mechanisms to direct the client to the second site. As an example, the well-known HTTP redirection mechanisms using a HTTP response code of 301, 302, 305 or 307 can be used to direct the client to second site, and back from the second site to the first site. The URL can encapsulate the location of the record in the database in a different number of ways. Similarly, the information correlating the two cookies can be store individually in the cookies itself instead of the database 207. This allows the database record entry to be removed after the second site has obtained the correlation information. The database 207 can also remove records on a least-recently used bases in order to free up the space, or it can remove a cookie entry after it has been inactive for some time. Since the cookie coordination database 207 servers the purpose of cookie coordination, it can be called a cookie coordinator.

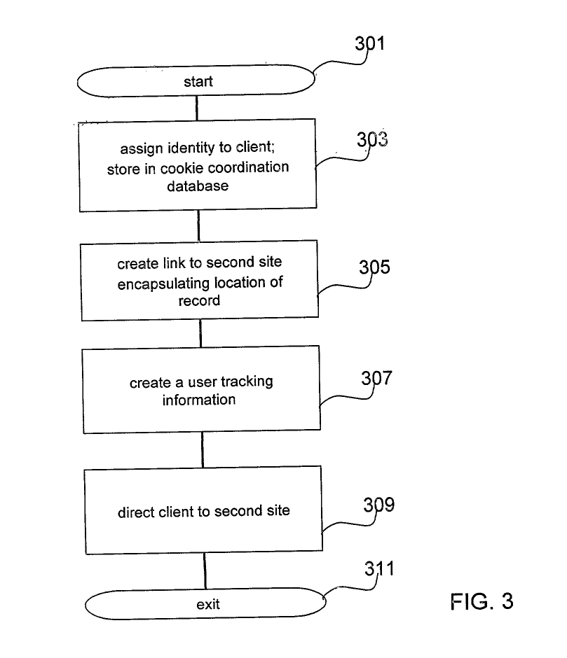

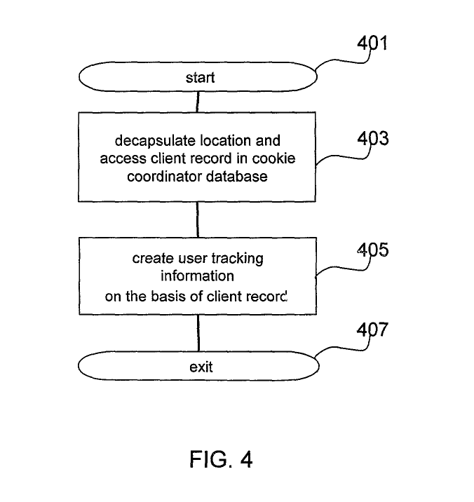

The steps involved in the cookie correlation as described in the environment of FIG. 2 are outlined in the flowcharts shown in FIG. 3 and FIG. 4. The steps of FIG. 3 are executed by the first web site when a client requests access to a page at the first web site at the initial step of 301. In the next step 303, the first web site assigns an identity to the client and stores a client record in the database. In the next step 305, the first web site creates a link for the second site which encapsulates information about the location of the client record in the cookie coordinator database. In the next step 307, the first web site creates an user-tracking mechanism for the user that includes the identity information. This mechanism could be a cookie or a rewritten tag within an uRL. In the step 309, the first web site directs the client to the second web site. The first web site then exits the algorithm in step 311.

The second web site executes the steps outlined in FIG. 4 when it receives the request from the redirected user. The algorithm is entered in step 401. In the next step 403, the second web site decpasulates the information about the location record for the client in the cookie coordinator. In step 405, the second web site uses the information in the client record accessed from the database in conjunction with its own user tracking mechanism to track the second user. It then exits the algorithm in step 407. The second site can use the same identifier for the user as the first web site, or it can use a different identifier and store the identifier information in the cookie coordinator database. In other cases, the second site can create a third identifier which includes both the identifier used at the first site, and the identifier used at the second site as sub-components, and store the third identifier as part of the user tracking mechanism.

In alternate embodiments of the present invention, the coordinated user information can be used in a variety of ways. One of the uses of the coordination information is to share access control and authentication information. As an example, the first web site may have authenticated the credentials of the users and created a cookie with the appropriate credentials. The second site wants to reuse the same credentials instead of asking the user to provide its credentials once again. The credential information can be stored in the cookie coordinator database, and the second site can look up the cookie coordinator database to check for credentials rather than challenging the user once again. This mechanism enables a single sign-on mechanism across the two domains to which two web-servers may belong.

Other embodiments employ the cookie coordination mechanism to create personalized pages for an user on the basis of the preferences or characteristics stored by the user at another site. As an example, an user may have stated that he has an interest in sports news when he created a personalized profile for the first web site. When the second web site can correlate its cookies with the cookies of the first web site, it can infer that the user is interested in sports news, and create pages incorporating sports news even though the user did not provide this information to the second web site. Thus, sharing of cookie information can lead to sharing of user preferences and other information across multiple domains.

In additional alternate embodiments of the present invention, each of the servers in different domains can maintain a private cookie at the browser; with each web server accessing the cookie coordinator when the private cookie it maintains is received by a web-server; and the cookie coordinator maps the identities contained in the cookies from different net domains to a single identity common across the multiple domains. In some cases, the single identity is stored in the private cookie maintained by the server in the domain.

In some of these additional alternate embodiments of the present invention, the embodiment may use a single identity for the users across the different domains. While each private cookie established in each domain contains a different identity, the cookie coordinator maintains a single identity which is used to correlate information from the different clients. The cookie coordinator learns the mapping of the various identities placed in each private cookie, and learns the mapping of the identities placed in the private cookie to the single identity.

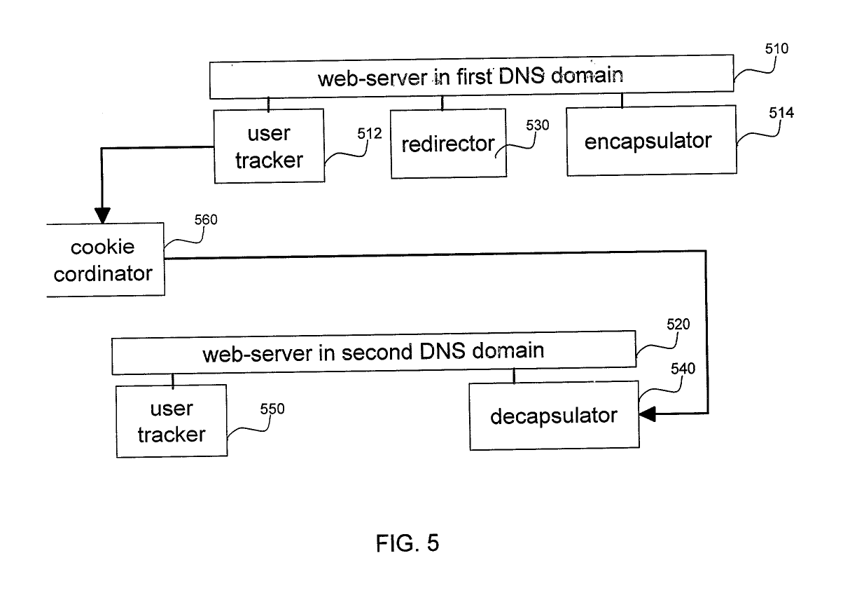

An additional alternate embodiments of the present invention, includes an apparatus shown in FIG. 5. The apparatus in FIG. 5 includes: a web server interface to interface with a first web server in a first DNS domain 510, and a second web server in a second DNS domain 520, wherein the first web server uses a first user tracker 512 to collect client information and stores the client information as a client record in a cookie coordinator database 560; a redirector 530 for the first web server directing a client to access a resource at the second web server; an encapsulator 514 for said resource encapsulating information about a location of the client record in the database; a decapsulator 540 for the second web server decapsulating the location and retrieving the client record from the database 560; and a second user tracker 550 for the second web server using the client record in conjunction with a second user tracking mechanism.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either or both of the following conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

Having thus described our invention, what I claim as new and desire to secure by Letters Patent is as follows:

1. A method comprising:
employing a first web server in a first DNS domain, and a second web server in a second DNS domain, wherein the first web server uses a first user tracking mechanism to collect client information and stores the client information as a client record in a database;
the first web server directing a client to access a resource at the second Web-Server;
said resource encapsulating information about a location of the client record in the database;
the second web server decapsulating the location and retrieving the client record from the database; and
the second web server using the client record in conjunction with a second user tracking mechanism.

2. A method as recited in 1, wherein the first and the second user tracking mechanisms use cookies for storing the user client information.

3. A method as recited in 1, wherein the first web server authenticates the client, and the client record includes user authentication data enabling the second web server to use a common sign-on with the sign-on of the first web server.

4. A method as recited in 1, wherein the first web server stores within the client record at least one parameter which determines at least one characteristic of at least one page to be sent to the client by the second web server.

5. A method as recited in 1, wherein said at least one parameter includes at least one user preference.

6. A method as recited in 5, wherein said at least one user preference is related to at least one detected purchasing habit.

7. A method comprising:
employing a first web server in a first DNS domain, and a second web server in a second DNS domain,
enabling said first and second web servers to share cookie information; and
coordinating cookies across said first and second domains.

8. A method as recited in claim 7, wherein the step of coordinating is performed by a cookie coordinator accessible to said first and second Web-Servers.

9. A method as recited in claim 7, further comprising providing a cookie coordinator accessible to said first and second Web-Servers to perform the step of coordinating.

10. A method as recited in claim 7, wherein the step of enabling includes the first web server setting a first cookie having a first identity and the second web server setting a second cookie having a second identity, and the step of coordinating maps the first and second identities to a third identity shared across said first and second domains.

11. An apparatus comprising:
means for employing a first web server in a first DNS domain, and a second web server in a second DNS domain, wherein the first web server uses a first user tracking mechanism to collect client information and stores the client information as a client record in a database;
means for the first web server directing a client to access a resource at the second web server;
means for said resource encapsulating information about a location of the client record in the database;
means for the second web server decapsulating the location and retrieving the client record from the database; and
means for the second web server using the client record in conjunction with a second user tracking mechanism.

12. An article of manufacture comprising a computer usable medium having computer readable program code means embodied therein for causing coordination of a first user tracking mechanism in a first web server and a second user tracking mechanism in a second web-server, the computer readable program code means in said article of manufacture comprising computer readable program code means for causing a computer to effect the steps of claim 1.

13. An article of manufacture comprising a computer usable medium having computer readable program code means embodied therein for causing coordination of a first user tracking mechanism in a first web server and a second user tracking mechanism in a second web-server, the computer readable program code means in said article of manufacture comprising computer readable program code means for causing a computer to effect the steps of claim 7.

14. A method comprising:
employing a first user tracker in a first domain, and a second user tracker in a second domain, wherein the first user tracker uses a first user tracking mechanism to collect client information and stores the client information as a client record in a database;
the first user tracker directing a client to access a resource at the second user tracker;
said resource encapsulating information about a location of the client record in the database;
the second user tracker decapsulating the location and retrieving the client record from the database; and
the second user tracker using the client record in conjunction with a second user tracking mechanism.

15. A program storage device readable by machine, tangibly embodying a program of instructions executable by the machine to perform method steps for tracking users, said method steps comprising the steps of claim 1.

16. A program storage device readable by machine, tangibly embodying a program of instructions executable by the machine to perform method steps for using cookies, said method steps comprising the steps of claim 7.

17. A computer program product comprising a computer usable medium having computer readable program code means embodied therein for causing tracking of users, the computer readable program code means in said computer program product comprising computer readable program code means for causing a computer to effect the functions of claim 11.

18. A method comprising:
employing a first web server in a first DNS domain, and a second web server in a second DNS domain, wherein the first web server maintains a first private cookie at a browser and the second web server maintains a second private cookie at the browser;
accessing a cookie coordinator when the first private cookie is received by the first web-server,; and
mapping a first identity in the first private cookie and a second identity in the second private cookie to a single identity common across the multiple domains.

19. A method as recited in claim 18, further comprising:
using the single identity to look up the identity of users across the different domains, and
the cookie coordinator learning the mapping of the various cookies that are placed independently on the browser by the different servers.

20. A program storage device readable by machine, tangibly embodying a program of instructions executable by the machine to perform method steps for tracking users, said method steps comprising the steps of claim 18.

21. An apparatus comprising:
a web server interface to interface with a first web server in a first DNS domain and to interface a second web server in a second DNS domain;
said first web server having:
a first user tracker to collect client information and stores client information as a client record in a cookie coordinator database;
a redirector for the first web server to direct a client to access a resource at the second web server;
an encapsulator for said resource to encapsulate information about a location of the client record in the database; and
said second web server having:
a second user tracker for the second web server to use the client record in conjunction with a second user tracking mechanism; and
a decapsulator for the second web server to decapsulate a location and retrieving the client record from the database.

22. A computer program product comprising a computer usable medium having computer readable program code means embodied therein for causing tracking of users, the computer readable program code means in said computer program product comprising computer readable program code means for causing a computer to effect the functions of claim 21.
